(19) United States
(12) Patent Application Publication
(10) Pub. No.: US 2004/0192108 A1
(43) Pub. Date: Sep. 30, 2004

(54) Contact stabilization by means of a primary latch reinforcement component

(75) Inventors: Bobby Gene Ward, King, NC (US); Wolfgang Hoelscher, Stokesdale, NC (US); Don Harold Crowe, Bermuda Run, NC (US)

Correspondence Address: TYCO ELECTRONICS CORPORATION, 4550 NEW LINDEN HILL ROAD, SUITE 450, WILMINGTON, DE, 19808, US

(73) Assignee: Tyco Electronics Corporation, Middletown, PA

(21) Appl. No.: 10/396,840

(22) Filed: Mar. 25, 2003

(51) Int. Cl. H01R 13/40

(52) U.S. Cl. 439/595

(57) ABSTRACT

The invention is directed to a terminal stabilization device utilizing primary latching reinforcement that is operable in an electrical connector assembly and includes a first housing unit having a contact member extending outwardly from a base surface of the first housing unit, a plurality of fingers protruding from the base surface of the first housing unit, a second housing unit having a contact member support positioned on the second housing unit to cradle the contact member, the contact member support having a plurality of engagement members extending therefrom, wherein when the upper housing unit and the lower housing unit are joined, the contact member, the fingers, and the engagement members form a receptacle for said terminal and said terminal is stabilized in position.

### FIELD OF THE INVENTION

The invention generally relates to contact stabilization mechanisms used in electrical connector assemblies, and more particularly to a stabilization alignment mechanism utilizing primary latching reinforcement operable in an electrical connector assembly.

### BACKGROUND OF THE INVENTION

Conventional connector assemblies, as used in automobiles and other vehicles, often face several types of problems. For example, one problem involves the engagement of the connector components. Because the electrical connector assembly is mated and then sealed, it is often difficult, if not impossible, to determine if the corresponding connectors are fully engaged with one another prior to catastrophic fatigue and failure. This is of particular concern when the assembly undergoes periods of vibration, which naturally occurs whenever the vehicle is in movement, or even if it is stationary and the engine is running.

Another problem involves unrestricted and excessive movement of the contact system within the electrical assembly housings, which invariably occurs during these periods of vibration. As such, contact stabilization systems have been devised to provide a proper stabilization of internal components. However, such conventional systems do not provide for proper alignment of internal assembly components, and the conventional designs simply allow too much internal component movement to occur, thereby allowing failure of the internal assembly components including the contact system, and of the assembly housings themselves.

Another problem with the conventional stabilization devices is that it is difficult to determine if the internal components and contact members, themselves, have been fully seated within the connector housings, especially after the housings have been sealed.

Conventionally, a terminal position assurance (TPA) member, such as a wedge-shaped structure, may be pre-mounted on a surface of a housing. This member then pushes the internal electrical components and terminals to fully seat them with respect to the remainder of the connector housing, and then snaps into place.

Another type of TPA member may include an insertable comb. The TPA comb is installed after the terminals have been inserted into the connector body and, usually, the TPA comb engages a shoulder of the terminal to interferingly prevent withdrawal of the terminals from the housing. Insertion of the comb may also be used to push the contacts forward into position.

Unfortunately, these conventional TPA devices do not provide adequate assurance that the internal terminals and other contact components are fully seated during periods of excessive vibration. Nor do these conventional TPA devices prevent excessive movement of the internal components of the assembly.

Therefore, there is a need for a novel stabilization alignment device used in electrical connector assemblies which utilizes position assurance, and which prevents damage to internal assembly components during periods of vibration of the assemblies.

### SUMMARY OF THE INVENTION

In view of the foregoing and other problems, disadvantages, and drawbacks of the conventional contact stabilization devices, various embodiments of the invention are disclosed herein. It is an advantage of various embodiments of the invention to provide a stabilization alignment device used in electrical connector assemblies that limits the movement of the contact member. It is another advantage of embodiments of the invention to provide a stabilization alignment device used in electrical connector assemblies, which utilizes primary latching reinforcement. Still another advantage of the embodiments of the invention is to provide a stabilization alignment device used in electrical connector assemblies, which prevents damage to internal assembly components during vibration.

In order to attain the advantages suggested above, there is provided, according to one aspect, a stabilization alignment device primary latching reinforcement assurance and operable in an electrical connector assembly, wherein the device comprises a first housing unit having an outer wall configured along an outer perimeter of the first housing unit, a contact member extending outwardly from a base surface of the first housing unit, a plurality of fingers protruding from the base surface of the first housing unit, wherein the fingers are arranged parallel to each longitudinal side of the contact member, and a support receptacle positioned on the second housing unit to cradle the contact member.

The second housing unit preferably includes a support wall, wherein the support wall has a notch thereon, and wherein the notch comprises a back portion having an inner surface and an outer surface. A protrusion on the first housing unit engages the outer surface of the back portion of the notch to ensure proper alignment of the connector.

Moreover, the contact member is preferably configured along a central axis of the first housing unit, and the support comprises a generally elongated central shaft having a plurality of engagement members aligned along each longitudinal side of the central shaft. The first housing unit further comprises a plurality of holes in the base surface, wherein the holes are dimensioned and configured to receive the terminal pins. Additionally, the second housing unit further comprises a plurality of wedge members, wherein the wedge members are dimensioned and configured to engage the fingers. The fingers comprise a step positioned on an edge of an upper surface of the fingers, wherein the second housing unit comprises a plurality of mounting tabs dimensioned and configured to engage the step on the fingers.

Embodiments of the invention overcome the several disadvantages of the conventional designs, and in particular, have an advantage over conventional stabilization alignment devices because movement of the contact member in the electrical connector assembly system is limited. Another advantage is that primary latching reinforcement position assurance is utilized to further its stabilization of internal device components. Still another advantage is that damage to internal assembly components during vibration is arrested and/or limited.

### BRIEF DESCRIPTION OF THE DRAWINGS

The foregoing and other aspects and advantages will be better understood from the following detailed description of the invention with reference to the drawings, in which:

FIG. 1 is a perspective view of a contact stabilization alignment device according to an embodiment of the invention;

FIGS. 2(a)-(b) are perspective views of a contact stabilization alignment device according to an embodiment of the invention; and

FIGS. 3(a)-(e) are views of an assembled contact stabilization alignment device shown in a closed position.

### DETAILED DESCRIPTION

It will be appreciated that the following description is intended to refer to specific embodiments of the invention selected for illustration in the drawings and is not intended to define or limit the invention, other than in the appended claims.

It will be readily appreciated that any relative terms used herein, such as “first”, “second”, “upper”, and “lower” are not intended to signify any particular arrangement or precedence of the element, but are used only to provide description of the invention.

As previously mentioned, there is a need for a novel stabilization alignment device used in electrical connector assemblies which utilizes contact position assurance, and which limits damage to internal assembly components during periods of vibration of the assemblies. Embodiments of the invention provide a stabilization alignment device used in electrical connector assemblies that utilizes contact position assurance, and which limits damage to internal assembly components during periods of vibration.

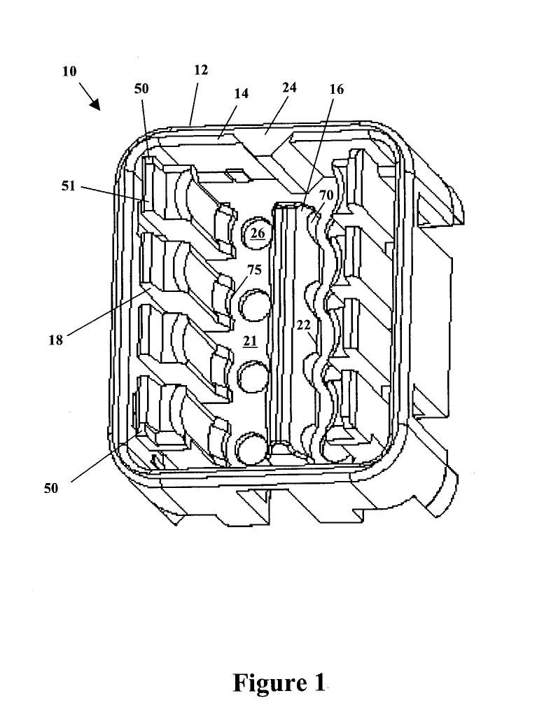

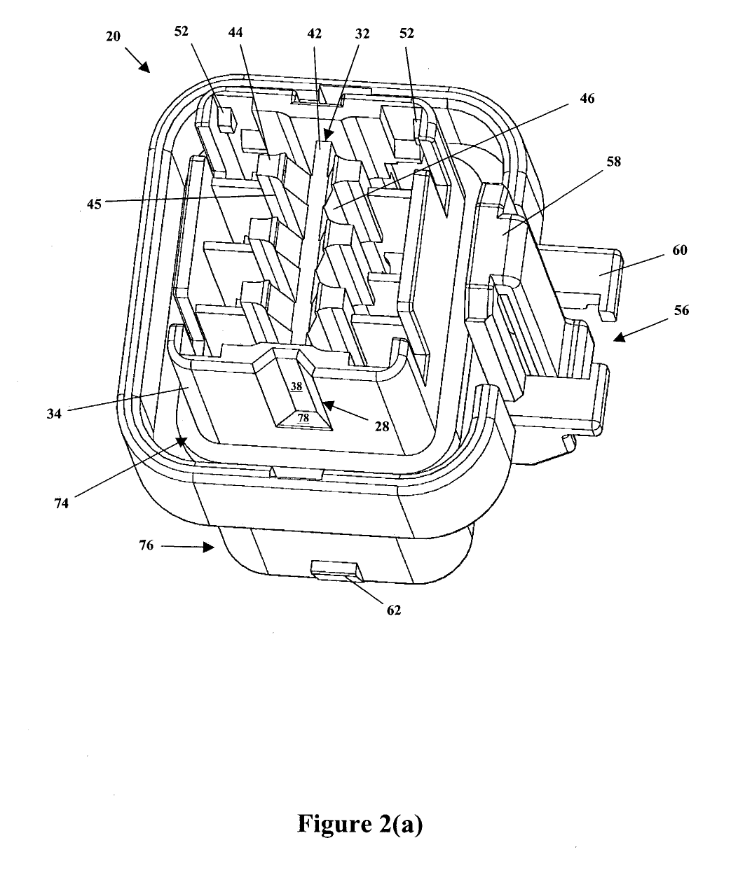

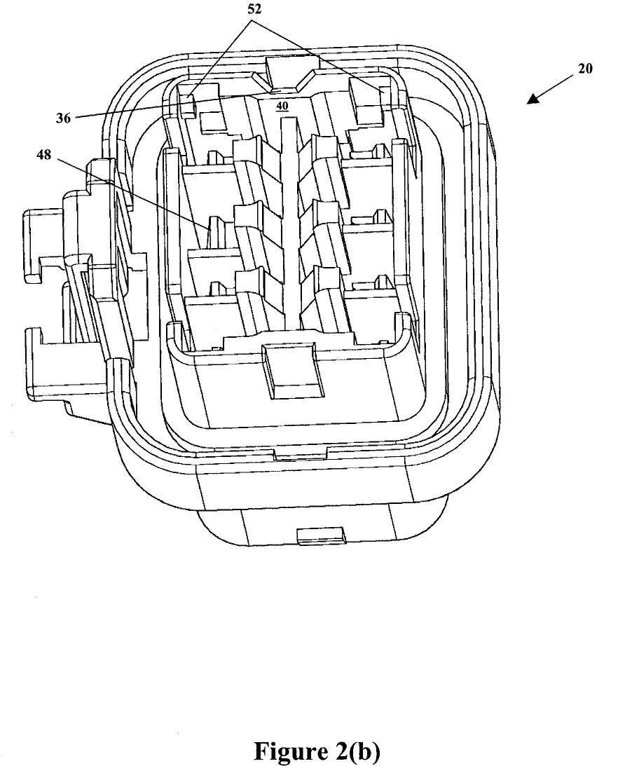

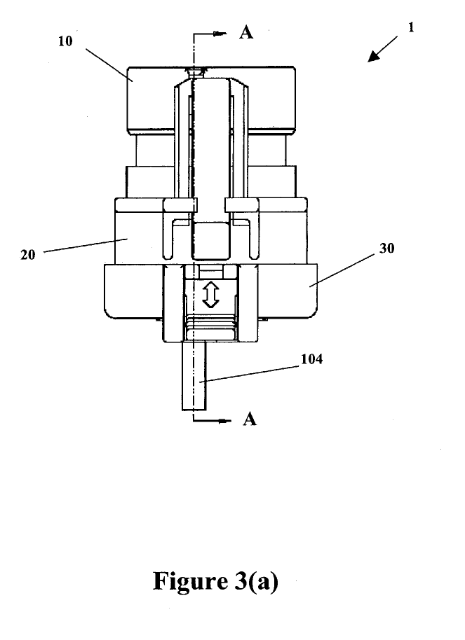

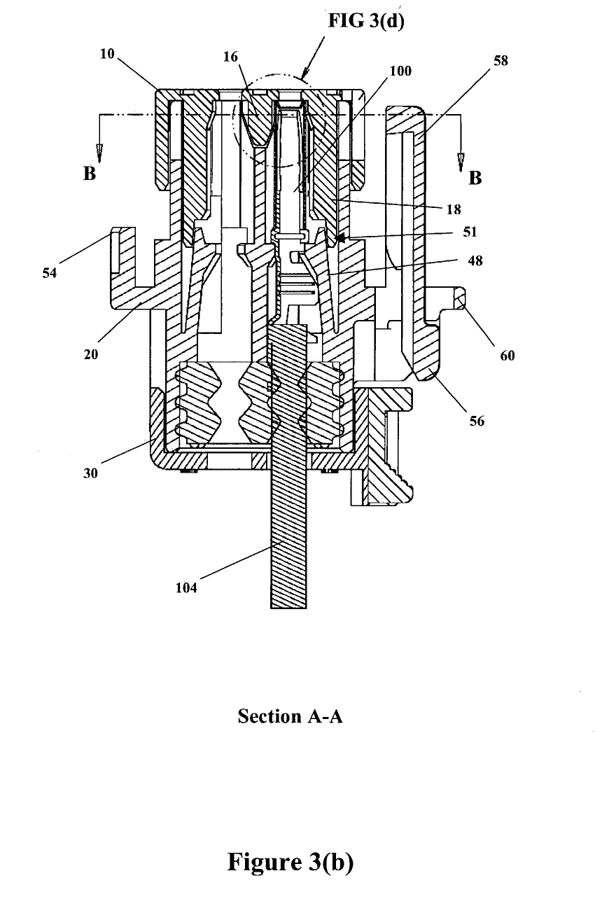

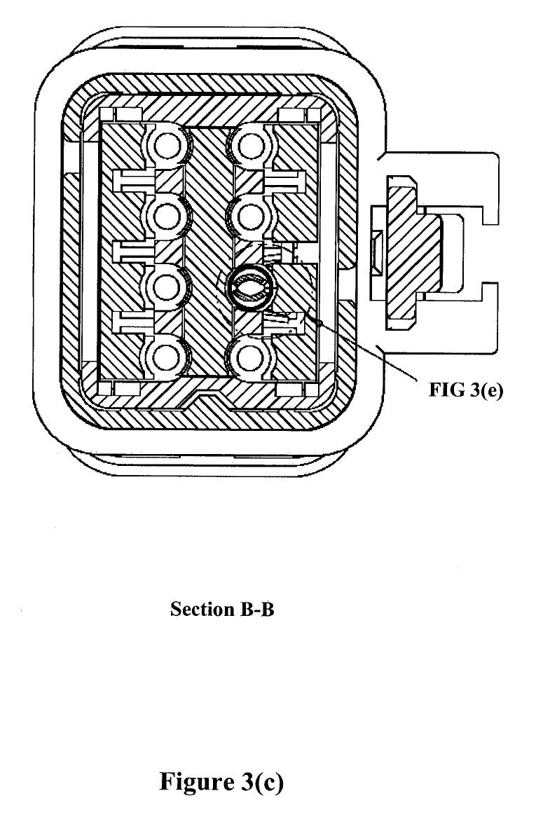

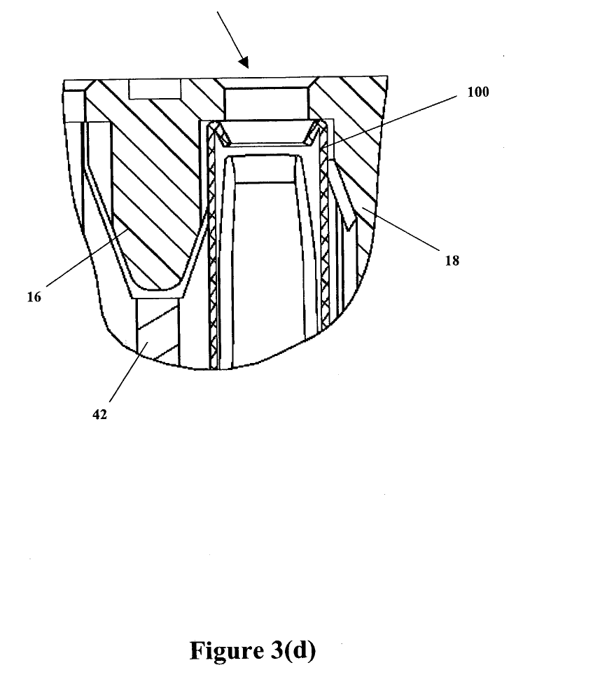

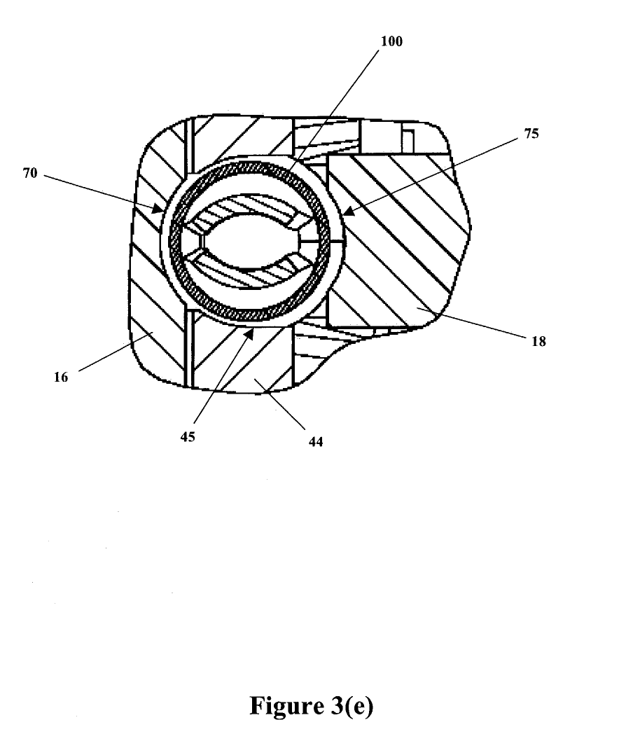

Referring now to the drawings, and to the Figures, there are shown exemplary embodiments of the structures according to the invention, wherein a first housing unit is illustrated in FIG. 1, a second housing unit in FIGS. 2(a)-(b), and a complete stabilization alignment device utilizing primary latching reinforcement operable in an electrical connector assembly is illustrated in detail in FIGS. 3(a)-(e).

As shown in FIG. 1, the device comprises a generally rectangular first housing unit 10, which is the upper housing unit of the assembly 1 (FIG. 3(a)), wherein the first housing unit 10 preferably comprises an outer wall 14 with an outer lip 12 configured along an outer perimeter of the first housing unit 10.

The device also preferably includes a generally elongated contact member 16 extending outwardly from a base surface 21 of the first housing unit 10, a plurality of primary locking fingers 18 protruding from the base surface 21 of the first housing unit 10, wherein the primary locking fingers 18 are arranged parallel and proximate to each longitudinal side 22 of the contact member 16. The primary locking fingers 18 preferably include a generally curvilinear base portion 75 extending up the primary locking finger 18. Similarly, contact member 16 preferably includes a plurality of curvilinear cutout portions 70 aligned on each longitudinal side 22 of the contact member 16. Moreover, the contact member 16 preferably has a generally beveled upper surface and is located along the central axis of the upper housing unit 10.

The second housing unit 20, shown in FIG. 2(a)-(b), represents the lower housing unit of the assembly 1. Second housing unit 20 preferably includes a support receptacle 32 positioned along the central axis of the second housing unit 20 to cradle the contact member 16 upon mating. Support 32 preferably comprises a generally elongated central shaft member 42 having a plurality of engagement members 44, having curved sidewalls 45, aligned along each longitudinal side 46 of the central shaft 42.

The first housing unit 10 further comprises a plurality of holes 26 in the base surface 21 (FIG. 1), wherein the holes 26 are dimensioned and configured to be aligned with terminal contacts 100 when they are inserted into the housings (FIG. 3). When second housing unit 20 and first housing unit 10 are brought together, engagement members 44 fit between primary locking fingers 18 and against contact member 16 so that the curved sidewalls 45 of engagement members 44, curvilinear base portion 75, and curvilinear cutout portions 70 form a receptacle for receiving terminal contacts 100 (FIG. 3), assuring that the terminal contacts are properly positioned and secured against excessive vibration.

The device also preferably includes a polarization feature to ensure proper alignment of the first and second housing. For example, a protrusion 24 may extend inwardly from the outer wall 14 and extend upwardly from the base surface 21 of first housing unit 10 (FIG. 1). While protrusion 24 is shown herein as generally wedged-shaped, it is not limited thereto,

The second housing unit 20 further preferably comprises a support wall 34 extending around an upper portion 74 of the second housing unit 20, wherein the support wall 34 includes a notch 28, and wherein the notch 28, in this embodiment, comprises a back portion 36 having an inner surface 40, a notch base surface 78, and an inner surface 38. Upon mating of the upper housing 10 with the lower housing 20, protrusion 24 engages both the notch base surface 78 and the inner surface 38 of the back portion 36 of the notch 28. Protrusion 24 ensures proper alignment and mating of the upper housing 10 with the lower housing 20 by only allowing the units to be coupled in one configuration.

Additionally, the second housing unit 20 may further comprise a plurality of latch finger members 48, wherein the latch finger members 48 are dimensioned and configured to engage the primary locking fingers 18 of the first housing unit 10, in the manner shown in FIG. 3(b). Primary locking fingers 18 are preferably positioned one adjacent to another, wherein each of the four end primary locking fingers 18 preferably include a step 50 positioned on an edge of an upper surface 51 of the primary locking fingers 18 (FIG. 1), wherein the second housing unit 20 comprises a plurality of mounting tabs 52 dimensioned and configured to engage the step 50 of the respective primary locking fingers 18 (FIGS. 2(a)-(b)).

The second housing unit 20 further preferably comprises a lower portion 76, locking latch 58, which includes a catch 62. Additionally, mounting flange 54 extends upwardly from said second housing unit 20, and is positioned as shown. Moreover, a locking latch 58 with a delatching pad 56 is preferably provided on the second housing unit 20, which includes a pair of over stress devices 60 for mounting in a vehicle or to another assembly.

FIG. 3(a) illustrates the assembly 1 once the upper housing unit 10 is aligned and mated with the lower housing unit 20. End cap 30 may also be included, through which conductor 104 passes. The internal components of both the upper housing unit 10 and lower housing unit 20, particularly the contact member 16, are shown fully engaged, aligned, and stabilized in FIG. 3(b). The assembly 1 shown in FIGS. 3(a)-(e) limits excessive movement using the support receptacle 32 as a cradle for the contact member 16. This cradling effect along with primary locking fingers 18, and contact member 16 allows for proper control of terminal contacts 100 and 104, which are secured into position.

In this embodiment, latch finger members 48 are forced against the lower portion of terminal contacts 100 by upper surface 51 of primary locking fingers 18 to provide a primary latching reinforcement (PLR) of terminal contacts 100 within the connector assembly.

Embodiments of the invention overcome the several disadvantages of the conventional designs, and in particular, has an advantage over conventional stabilization alignment devices because of utilizing a novel design which limits the movement of the contact member in the electrical connector assembly system. Another advantage of embodiments of the invention is that it utilizes primary latching reinforcement to further its stabilization of internal device components. Still another advantage of embodiments of the invention is that it prevents damage to internal assembly components during vibration.

Although this invention has been described with reference to particular embodiments, it will be appreciated that many variations may be resorted to without departing from the spirit and scope of this invention as set forth in the appended claims.

What is claimed is:

1. A terminal stabilization device comprising:
an upper housing unit comprising a base portion;
a contact member extending from said base portion;
a plurality of fingers extending from said base portion; and
a lower housing unit having a contact member support positioned to cradle said contact member, said support having a plurality of engagement members extending therefrom;
wherein when said upper housing unit and said lower housing unit are joined, said contact member, said fingers, and said engagement members form a receptacle for said terminal and said terminal is stabilized in position.

2. The stabilization device of claim 1, wherein said upper housing further comprises an alignment protrusion extending therefrom and said lower housing comprises an alignment receptacle for receiving said alignment protrusion, wherein the engagement of said alignment protrusion with said receptacle properly aligns said upper housing unit with said lower housing unit.

3. The stabilization device of claim 2, wherein said lower housing unit further comprises a support wall, wherein said alignment receptacle comprises a notch in said support wall.

3. The stabilization device of claim 1, wherein said contact member is configured along a central axis of said upper housing unit.

4. The stabilization alignment device of claim 1, wherein said lower housing unit further comprises a plurality of wedge members, and wherein said wedge members are dimensioned and configured to engage said fingers to provide primary latching reinforcement to said terminal.

5. The stabilization device of claim 1, wherein said fingers further comprise a step positioned on an edge of an upper surface of said fingers, and wherein said lower housing unit further comprises a plurality of mounting tabs dimensioned and configured to engage said step of said fingers.

6. A stabilization device comprising:
a first housing unit having an outer wall configured along an outer perimeter of said first housing unit;
a contact member extending outwardly from a base surface of said first housing unit;
a plurality of fingers protruding from said base surface of said first housing unit, wherein said fingers are arranged parallel to each longitudinal side of said contact member;
a first polarization feature extending from said outer wall;
a second housing unit having a support wall having a second polarization feature configured therein for mating with said first polarization feature; and
a contact member support positioned on said second housing unit to cradle said contact member, said contact member support having a plurality of engagement members extending therefrom;
wherein when said upper housing unit and said lower housing unit are joined, said contact member, said fingers, and said engagement members form a receptacle for said terminal and said terminal is stabilized in position.

7. The stabilization device of claim 6, wherein said second polarization feature comprises a notch.

8. The stabilization device of claim 6, wherein said contact member is configured along a central axis of said first housing unit.

9. The stabilization device of claim 6, wherein said second housing unit further comprises a plurality of wedge members, and wherein said wedge members are dimensioned and configured to engage said fingers to provide primary locking reinforcement to said terminal.

10. The stabilization device of claim 6, wherein said fingers further comprise a step positioned on an edge of an upper surface of said outer fingers.

11. The stabilization device of claim 10, wherein said second housing unit comprises a plurality of mounting tabs dimensioned and configured to engage said groove of said fingers.
